(19) United States
(12) Patent Application Publication
(10) Pub. No.: US 2011/0143758 A1
(43) Pub. Date: Jun. 16, 2011

(54) METHOD OF HANDOVER BETWEEN PRIVATE BASE STATIONS

(75) Inventor: Hyung Deug BAE, Daejeon (KR)

(73) Assignee: Electronics and Telecommunications Research Institute, Daejeon (KR)

(21) Appl. No.: 12/909,550

(22) Filed: Oct. 21, 2010

(30) Foreign Application Priority Data
Dec. 16, 2009 (KR) 10-2009-0125225

(51) Int. Cl. H04W 36/00

(52) U.S. Cl. 455/436

(57) ABSTRACT

A method acquires load status information of an adjacent private base station to perform handover between private base stations. The method includes: receiving the load status information from a terminal that has received base station system information which includes the load status information, indicating the status of radio resource use of the adjacent base station, with the system information having been broadcast by the adjacent private base station, and storing the received load status information of the adjacent base station.

### CROSS-REFERENCE(S) TO RELATED APPLICATION

The present invention claims priority of Korean Patent Application No. 10-2009-0125225, filed on Dec. 16, 2009, which is incorporated herein by reference.

### FIELD OF THE INVENTION

The present invention relates to a handover method of a mobile terminal between private base stations, and more particularly, to a handover method of a mobile terminal between private base stations, which avoids an unnecessary handover to a private base station having an overload status of radio resource allocation via restricting the handover to the overloaded private base station.

### BACKGROUND OF THE INVENTION

Terminals and wireless access points implementing IEEE 802.11x standards for WLAN (Wireless Local Area Network) or WiFi (Wireless-Fidelity) have been available in markets, but, recently, private base stations implementing cellular radio telecommunication standards have entered the market. A private base station is a private base station owned by an individual or company, and is called by many names, such as home base station, home eNodeB, femto eNodeB and the like. The private base station is a consumer device and, thus, is not under the control of a cellular network service provider. The private base station is supplied on the market so that consumers can buy and install it without technical support from the network service provider in a relative small area such as a house or an office. The private base station provides coverage and service to user terminals (hereinafter, referred to as subscribed terminals) registered by the owner of the private base station. The private base station is connected to a core network of the network service provider via a Digital Subscriber Line (DSL) for Internet communications.

The conventional requirement for private base stations permits only terminals having access rights to be connected to the private base stations. However, a requirement for private base stations has been recently added to permit terminals having no access rights (referred to as non-subscribed terminals), as well as subscribed terminals, to be connected to the private base stations. Even though the private base stations permit non-subscribed terminals to be connected thereto, they are required to guarantee the priority of subscribed terminals in terms of control of access among subscribed terminals or non-subscribed terminals or in terms of radio resource allocation.

For example, when a non-subscribed terminal requests a handover to a private base station of which radio resources are insufficient, the private base station may restrict the handover to the non-subscribed terminal in order to guarantee the quality of service (QoS) to subscribed terminals. This policy is for private base stations to give priority to subscribed terminals in radio resource allocation and the like. In case radio resources are insufficient in a private base station, the private base station may collect radio resources allocated to non-subscribed terminals which is already connected thereto or may reject a handover requested by non-subscribed terminals, if any, to thereby preferentially process a new request for handover or radio resource allocation from another subscribed terminals.

As the handover requested by non-subscribed terminals is rejected by the private base station, the non-subscriber terminal has to search for a new private base station and may experience wireless link disconnection due to waste of time in the searching. In addition, an unnecessary handover procedure performed between a serving base station and a destination base station may cause a network overhead.

### SUMMARY OF THE INVENTION

Therefore, the present invention provides a handover method to avoid unnecessary handover to a private base station of which status of radio resource allocation is overloaded by notifying an adjacent base station with the overload status.

In accordance with a first aspect of the present invention, there is provided a method for allowing a serving base station to acquire information on a radio resource allocation of adjacent base stations to perform a handover of a mobile terminal requesting the handover to the serving base station. The method includes: receiving a status of radio resource allocation for the adjacent base stations indicating a normal status or an overload status, wherein the adjacent base stations broadcast their status of radio resource allocations accompanied by their system information, and the status of radio resource allocations accompanied by their system information are received through the mobile terminal; and storing the status of radio resource allocations.

In accordance with a second aspect of the present invention, there is provided a method for allowing a base station to broadcast a status of radio resource allocation thereof to perform a handover of a mobile terminal requesting the handover. The method includes: monitoring a radio resource allocation; determining a status indicative of a normal status or an overload status of the radio resource allocation; and broadcasting the status of the radio resource allocation accompanied by system information of the base station.

In accordance with a third aspect of the present invention, there is provided a method for allowing a mobile terminal to transmit a status of radio resource allocations for adjacent base stations to a serving base station to perform a handover of the mobile terminal requesting the handover. The method includes: receiving system information for the adjacent base stations, wherein the system information incorporate therein the status of radio resource allocations indicative of an overload status or a normal status and are broadcasted from the adjacent base stations; extracting the status from the received system information; and transmitting the extracted status to the serving base station.

In accordance with a fourth aspect of the present invention, there is provided a method of performing a handover of a mobile terminal requesting the handover at a serving base station of the mobile terminal. The method includes: acquiring system information for adjacent base stations through the mobile terminal, wherein the system information incorporate a status of radio resource allocations for the adjacent base stations therein and are broadcasted and received by the mobile terminal; storing the acquired status of radio resource allocations; determining a destination base station for handover based on the status of radio resource allocations; and performing the handover to the determined handover destination base station.

In accordance with a fifth aspect of the present invention, there is provided a base station for providing a handover to a non-subscribed terminal requesting the handover. The base station includes: a monitoring unit for monitoring a radio resource allocation of the base station to determine a normal status or an overload status of the radio resource allocation; a broadcasting unit for broadcasting the status determined by the monitoring unit accompanying by system information of the base station; a communication unit for communicating with the mobile terminal; a storage unit for storing a status of radio resource allocations for adjacent base station; and a selection unit for selecting a handover destination station for the mobile terminal based on the status of radio resource allocations stored in the storage unit.

In accordance with a sixth aspect of the present invention, there is provided a mobile terminal for notifying a status of radio resource allocation for adjacent base stations with a serving base station of the mobile terminal requesting a handover. The terminal includes: a broadcast reception unit for receiving system information broadcasted by the adjacent private base stations, wherein the system information incorporates the status of radio resource allocations therein; a status information processing unit for extracting the status from the received system information; and a communication unit for transmitting the status to the serving base station.

### BRIEF DESCRIPTION OF THE DRAWINGS

The other objects and features of the present invention will become apparent from the following description of embodiments, given in conjunction with the accompanying drawings, in which:

FIG. 1 is a conceptual view showing transmission of a status of radio resource allocation between a private base station and a terminal in a private base station system in accordance with an embodiment of the present invention;

FIG. 2 is a schematic block diagram of a private base station shown in FIG. 1 in accordance with the embodiment of the present invention;

FIG. 3 is a schematic block diagram of a terminal shown in FIG. 1 in accordance with the embodiment of the present invention;

FIG. 4 is a flowchart illustrating a process in which the terminal processes the status of radio resource allocation received from an adjacent base station in accordance with the embodiment of the present invention;

FIG. 5 is a flowchart illustrating a process in which the base station processes the status of the radio resource allocation in accordance with the embodiment of the present invention; and

FIG. 6 is a flowchart illustrating a process in which the base station performs handover based on the status of radio resource allocation in accordance with the embodiment of the present invention.

### DETAILED DESCRIPTION OF THE EMBODIMENTS

Hereinafter, embodiments of the present invention will be described in detail with reference to the accompanying drawings which form a part hereof.

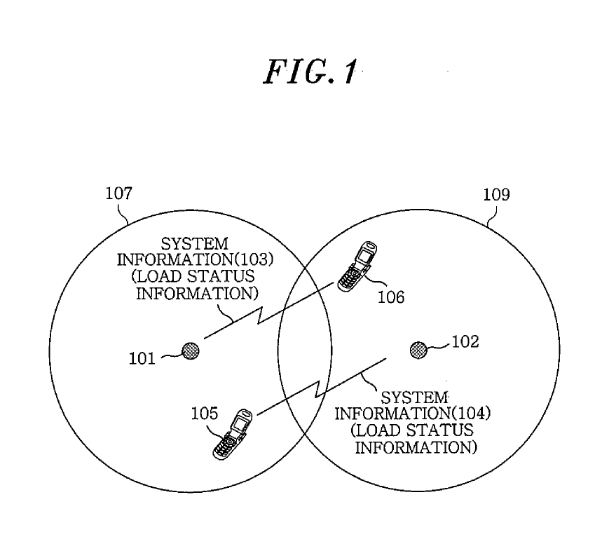

FIG. 1 is a conceptual view showing transmission of the status of radio resource allocation between a private base station and a terminal in a private base station system in accordance with an embodiment of the present invention.

As shown in FIG. 1, a private base station 101 and a private base station 102 broadcast their system information. Each of the private base stations 101 and 102 monitor their status of radio resource allocations to determine whether the status of radio resource allocation is a normal status or an overload status at every preset time interval. The information on the status of radio resource allocations are incorporated in their system information 103 and 104 and then broadcasted.

The status of the radio resource allocation may be broadcast whenever the radio resource allocation of the private base station 101 or private base station 102 changes between a normal status and an overload status. That is, when the normal status is changed to the overload status or the overload status is changed to the normal status, the system information is broadcast.

On the other hand, when an overload status is determined at the every preset time interval, the load status information is broadcast.

A mobile terminal 105 receives the system information 104 broadcasted from its adjacent base stations 102 and transmits it in a wireless manner via a network to the private base station 101 which acts as a serving base station of the terminal 105 at a cell 107. Similarly, a mobile terminal 106 also receives the system information 103 broadcasted from its adjacent base stations 101 and transmits it in a wireless manner via a network to the private base station 102 which acts as a serving base station of the terminal 106 at a cell 109.

Each of the mobile terminals 105 and 106 may be a subscribed terminal or a non-subscribed terminal under the private base station service, and may includes, but not limited thereto, a cellular telephone, a mobile phone, a smartphone, a two-way radio, a two-way pager, a wireless messaging device, a laptop/computer, and the like to name a few.

The private base station 101, having acquired the system information 103 for the adjacent base stations 102, extracts the status information of radio resource allocation for the private base station 102 to determine whether the base station 102 is in an overload status or not on a basis of the status of radio resource allocation. If the base station 102 is determined to be in the overload status, the base station 101 excludes the base station 102 from candidate base stations for handover. Therefore, an unnecessary handover procedure to be caused by handover rejection can be avoided via restricting handover to the overloaded base station, thereby reducing network overhead and enabling a mobile terminal to perform more stable handover by selecting an appropriate destination cell immediately without a waste of time and attempting handover.

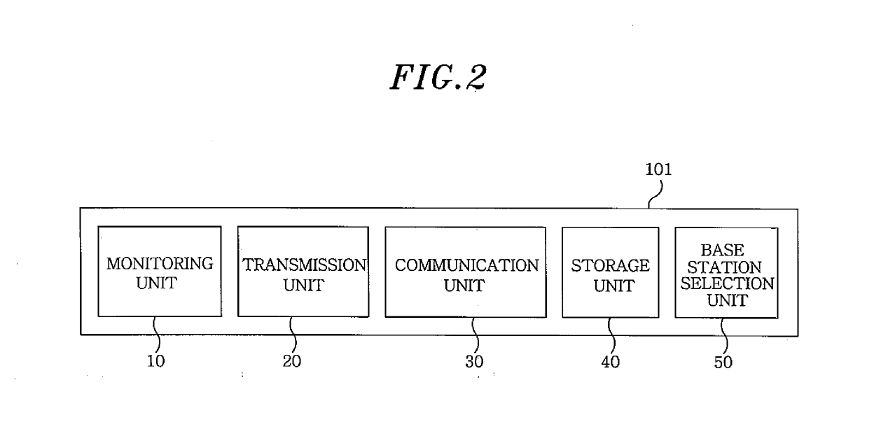

FIG. 2 is a schematic block diagram of a private base station shown in FIG. 1 in accordance with the embodiment of the present invention.

For simple illustration, only one of the private base stations 101 and 102, for example, a private base station 101 is shown in FIG. 2. The private base stations 101 include a monitoring unit 10, a broadcasting unit 20, a communication unit 30, a storage unit 40, and a selection unit 50.

The monitoring unit 10 monitors the radio resource allocation of the base station 101 to determine a status of radio resource allocation, i.e., a normal status or an overload status at every preset time interval.

The broadcasting unit 20 broadcasts information on the status of radio resource allocation determined by the monitoring unit 10, which is accompanying by system information of the base station 101.

According to the present invention, the broadcasting unit may broadcast the status of resource allocation whenever the status changes between the normal status and the overload status. Alternatively, the broadcasting unit 20 may broadcast the status of radio resource allocation at every preset time interval.

The storage unit 40 stores the status of radio resource allocation for the adjacent base stations received through the mobile terminal 105. The status of radio resource allocation becomes updated upon acquiring the status of radio resource allocation of the adjacent base stations through the mobile terminal.

The selection unit 50 selects a destination base station for a terminal requesting handover based on the status of radio resource allocation stored in the storage unit 40. Further, the selection unit 50 includes a list of handover destination base stations in which candidate base stations are provided as possible handover destinations. From the list of handover destination base stations, the selection unit 50 deletes a candidate base station determined to be in an overload status based on the status of radio resource allocation stored in the storage unit 40. In addition, the selection unit 50 also adds a candidate base station determined to be in a normal status based on the status of resource allocation into the list of handover destination base stations. With this, the selection unit 50 selects a destination base station for handover based on the list of handover destination base stations.

The communication unit 30 communicates the mobile terminal 105 within the coverage of the cell 107. Further, the communication unit 30 receives the status of radio resource allocations broadcasted from adjacent base stations and received through the subscriber terminal 105, and transmits the handover destination base station selected by the selection unit 50 to the mobile terminal requesting the handover.

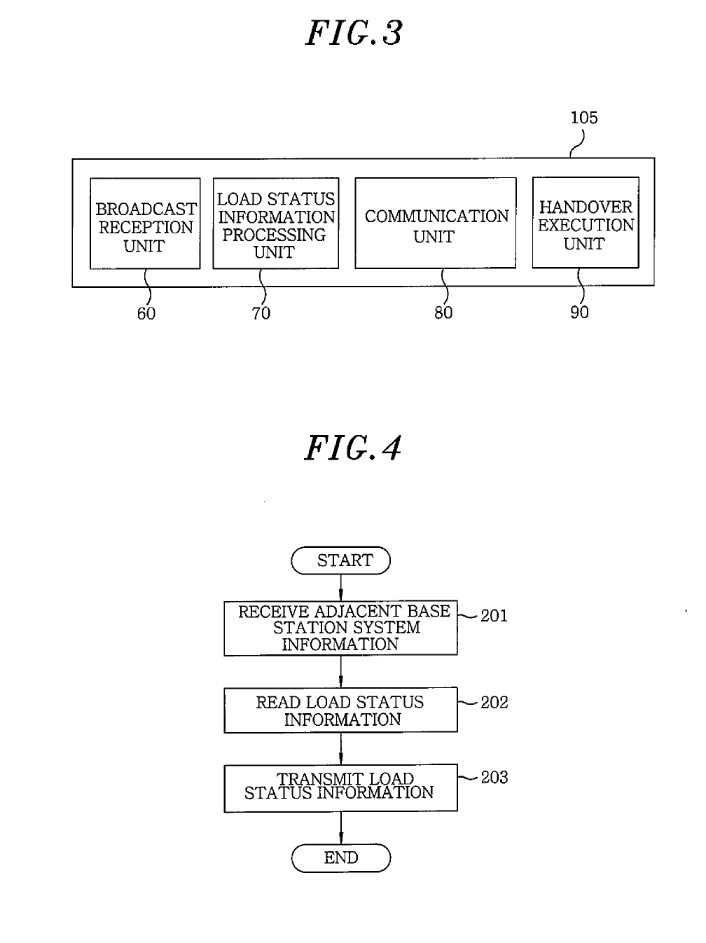

FIG. 3 is a schematic block diagram of a terminal shown in FIG. 1. For simple illustration, only one of the terminals 105 and 106, for example, a terminal 105 is shown in FIG. 3.

As shown in FIG. 3, the mobile terminal 105 includes a broadcast reception unit 60, a load status information processor 70, a communication unit 80 and a handover execution unit 90.

The broadcast reception unit 60 receives system information of the adjacent base stations 102, wherein the system information contains the status of radio resource allocation indicative of the overload status or the normal status for the adjacent base stations.

The status information processor 70 extracts information on the status of radio resource allocation from the system information. Then, the communication unit 80 transmits the extracted information to the serving private base station 101.

The handover execution unit 90 performs handover to the selected destination base station for handover by the serving private base station 101 based on the status of radio resource allocation.

FIG. 4 is a flowchart illustrating a process in which a mobile terminal processes the status of radio resource allocation received from an adjacent base station in accordance with the embodiment of the present invention.

Referring to FIG. 4, a mobile terminal, e.g., a terminal 105 receives the system information of the adjacent base stations 102 in step 201 and extracts a status of radio resource allocations from the system information in step 202. Then, the terminal 105 transmits the extracted status to the serving base station 101 in step 203.

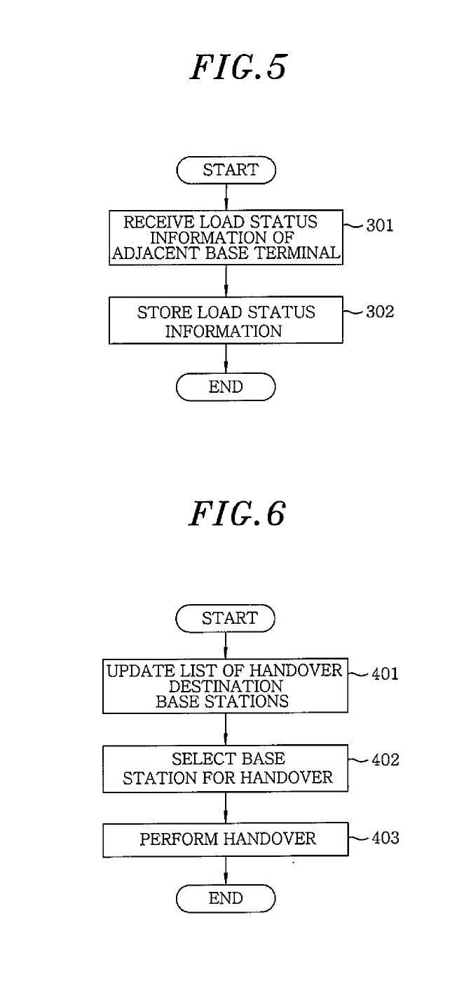

FIG. 5 is a flowchart illustrating a process in which a private base station processes the status of the radio resource allocation in accordance with the embodiment of the present invention.

A private base station, e.g., a private base station 101 receives the information on the status of radio resource allocation for the adjacent base stations 102 through the terminal 105 in step 301, and stores the status information in the storage unit 40 in step 302.

FIG. 6 is a flowchart illustrating a process in which a private base station performs handover based on a status of radio resource allocation in accordance with the embodiment of the present invention.

As explained above with reference to FIG. 3, the selection unit 50 in the private base station 101 updates the list of handover destination stations by deleting an adjacent base station in an overload status from the list or adding an adjacent base station in a normal status into the list on the basis of the status of radio resource allocation for the adjacent base stations 102 stored in the storage unit 40 in step 401.

A destination base station for handover is selected from the updated list of handover destination stations in step 402, and handover to the base station is performed by transmitting the selected destination base station for handover to the terminal 105 requesting handover in step 403.

As described above, in accordance with the embodiment of the present invention, a base station that has acquired the overload status of radio resource allocation for an adjacent cell can reduce network overhead due to an unnecessary handover procedure between a serving base station and a destination base station caused by handover rejection via restricting handover to the overloaded base station, and enabling a terminal to perform more stable handover by selecting an appropriate destination cell immediately without a waste of time and attempting handover.

While the invention has been shown and described with respect to the particular embodiments, it will be understood by those skilled in the art that various changes and modifications may be made without departing from the scope of the invention as defined in the following claims.

What is claimed is:

1. A method for allowing a serving base station to acquire information on a radio resource allocation of adjacent base stations to perform a handover of a mobile terminal requesting the handover to the serving base station, the method comprising:
receiving a status of radio resource allocation for the adjacent base stations indicating a normal status or an overload status, wherein the adjacent base stations broadcast their status of radio resource allocations accompanied by their system information, and the status of radio resource allocations accompanied by their system information are received through the mobile terminal; and
storing the status of radio resource allocations.

2. The method of claim 1, further comprising:
updating a list of handover destination base stations in which candidate base stations are provided as possible handover destinations by deleting a candidate base station having the overload status from the list or adding a candidate base station having the normal status into the list, based on the stored status of radio resource allocation.

3. A method for allowing a base station to broadcast a status of radio resource allocation thereof to perform a handover of a mobile terminal requesting the handover, the method comprising:
monitoring a radio resource allocation;
determining a status indicative of a normal status or an overload status of the radio resource allocation; and
broadcasting the status of the radio resource allocation accompanied by system information of the base station.

4. A method for allowing a mobile terminal to transmit a status of radio resource allocations for adjacent base stations to a serving base station to perform a handover of the mobile terminal requesting the handover, the method comprising:
receiving system information for the adjacent base stations, wherein the system information incorporate therein the status of radio resource allocations indicative of an overload status or a normal status and are broadcasted from the adjacent base stations;
extracting the status from the received system information; and
transmitting the extracted status to the serving base station.

5. A method of performing a handover of a mobile terminal requesting the handover at a serving base station of the mobile terminal, the method comprising:
acquiring system information for adjacent base stations through the mobile terminal, wherein the system information incorporate a status of radio resource allocations for the adjacent base stations therein and are broadcasted and received by the mobile terminal;
storing the acquired status of radio resource allocations;
determining a destination base station for handover based on the status of radio resource allocations; and
performing the handover to the determined handover destination base station.

6. The method of claim 5, wherein said determining a handover destination base station includes:
updating a list of destination base stations for handover by deleting an adjacent base station determined to be in an overload status from the list or adding the adjacent base station determined to be in a normal status into the list, based on the status of radio resource allocations; and
selecting the handover destination base station based on the updated list.

7. The method of claim 5, wherein the base stations include private base stations, respectively.

8. The method of claim 7, wherein the mobile terminal is a non-subscribed mobile terminal which is not registered by the owner of the base station.

9. A base station for providing a handover to a non-subscribed terminal requesting the handover, comprising:
a monitoring unit for monitoring a radio resource allocation of the base station to determine a normal status or an overload status of the radio resource allocation;
a broadcasting unit for broadcasting the status determined by the monitoring unit accompanying by system information of the base station;
a communication unit for communicating with the mobile terminal;
a storage unit for storing a status of radio resource allocations for adjacent base station; and
a selection unit for selecting a handover destination station for the mobile terminal based on the status of radio resource allocations stored in the storage unit.

10. The base station of claim 9, wherein the storage unit includes a list of handover destination base stations on a basis of the status of radio resource allocations.

11. The base station of claim 10, wherein the storage unit updates the list of handover destination stations by deleting an adjacent base station determined to be in an overload status from the list or adding an adjacent base station determined to be in a normal status into the list, based on the status of radio resource allocations.

12. The base station of claim 11, wherein the selection unit selects the handover destination station on a basis of the updated list.

13. The base station of claim 9, wherein the monitoring unit determines the overload status or the normal status of radio resource allocation at every preset interval.

14. The private base station of claim 13, wherein the broadcasting unit broadcasts the status of radio resource allocation at the every preset interval

15. The private base station of claim 13, wherein the broadcasting unit broadcasts the status of radio resource allocation whenever there is a change between the normal status and the overload status.

16. A mobile terminal for notifying a status of radio resource allocation for adjacent base stations with a serving base station of the mobile terminal requesting a handover, the terminal comprising:
a broadcast reception unit for receiving system information broadcasted by the adjacent private base stations, wherein the system information incorporates the status of radio resource allocations therein;
a status information processing unit for extracting the status from the received system information; and
a communication unit for transmitting the status to the serving base station.

17. The terminal of claim 16, further comprising:
a handover execution unit for performing the handover a destination base station selected by the serving base station based on the status of radio resource allocations.
